(19) United States
(12) Patent Application Publication
(10) Pub. No.: US 2011/0317351 A1
(43) Pub. Date: Dec. 29, 2011

(54) SERVER DRAWER

(75) Inventors: Katie L. Pizzolato, Austin, TX (US); Michael F. Scanlon, Poughkeespie, NY (US); Philip A. Sciuto, LaGrange, NY (US); Daniel J. Stigliani, JR., Hopewell Junction, NY (US)

(73) Assignee: INTERNATIONAL BUSINESS MACHINES CORPORATION, Armonk, NY (US)

(21) Appl. No.: 12/821,221

(22) Filed: Jun. 23, 2010

(51) Int. Cl. G06F 1/16

(52) U.S. Cl. 361/679.4; 361/695; 361/679.48

(57) ABSTRACT

A server Input/Output (I/O) drawer for holding one or more communication cards and one or more I/O cards includes an outer housing, a back plane within the outer housing that divides the drawer into a front portion and back portion, the back plane including a front side and a backside and configured to receive the one or more I/O cards and the one or more communications cards, and an air movement device (AMD) disposed within the front portion, a distribute current assembly (DCA) that receives a voltage from an external source and supplies power, through the backplane, to the AMD.

### BACKGROUND

The present invention relates to servers and, more specifically, to drawers for holding server input/output cards.

Input/output (I/O) hubs are often used in server computing devices to allow multiple I/O devices to be connected to the server computing device and manage the I/O operations performed between the I/O devices and the server computing device's processors, memory, and other resources. Typically, such I/O hub adapters are provided in the host system and are coupled to remote I/O drawers, in which I/O adapters (e.g., PCI or PCI-X adapters) and/or disk devices may be installed, through cabling links, e.g., Remote Input/Output (RIO) cabling links. The I/O drawers typically contain two I/O planars having slots and/or disk bays into which I/O adapter cards may be installed.

FIG. 1 is an exemplary diagram illustrating a server computing system. As shown in FIG. 1, the server computing system 100 includes server computing device 110 having a system frame 115 into which a plurality of operating components are installed. These operating components include a bulk power assembly 120, a central electronics complex (CEC) 130 in which the processors, memory, and I/O hub adapters are provided, and a plurality of I/O drawers 140.

The I/O drawers 140 each have two I/O planars (not shown) which each have a plurality of ports and/or SCSI interfaces with which I/O devices may be coupled, e.g., PCI or PCI-X adapters, hard disks, and the like. The I/O planars of the I/O drawers 140 are coupled to the I/O hub adapters of the CEC 130 via communication cable links, e.g., RIO-2 cable links. The CEC 130, for purposes of the present description, may constitute the “host system,” with the I/O drawers being remote from the host system such that communication between the host system and the I/O devices coupled to the I/O drawers 140 is facilitated by these cable links.

### SUMMARY

According to one embodiment of the present invention, a server Input/Output (I/O) drawer for holding one or more communication cards and one or more I/O cards is disclosed. The drawer of this embodiment includes an outer housing and a back plane within the outer housing that divides the drawer into a front portion and back portion. The back plane includes a front side and a backside and is configured to receive the one or more I/O cards and the one or more communications cards. The drawer of this embodiment also includes an air movement device (AMD) disposed within the front portion and a distribute current assembly (DCA) that receives a voltage from an external source and supplies power, through the backplane, to the AMD.

According to another embodiment of the present invention, a drawer for holding one or more communication cards and one or more I/O cards server is disclosed. The drawer of this embodiment includes an outer housing and a back plane within the outer housing that divides the drawer into a front portion and back portion. The back plane includes a front side and a backside and is configured to receive the one or more I/O cards and the one or more communications cards in a front receiving area and a back receiving area. The drawer of this embodiment also includes an air movement device (AMD) disposed within the front portion and above the front receiving area and a distributed current assembly (DCA) to provide power to the backplane, the DCA disposed within the back portion and below the back receiving area.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is an exemplary diagram illustrating a server computing system;

FIG. 2 is a perspective view of a drawer according to one embodiment;

FIG. 3 shows a side view of drawer 300 according to one embodiment; and

FIG. 4 shows a topological view of a backplane 402 according to one embodiment.

### DETAILED DESCRIPTION

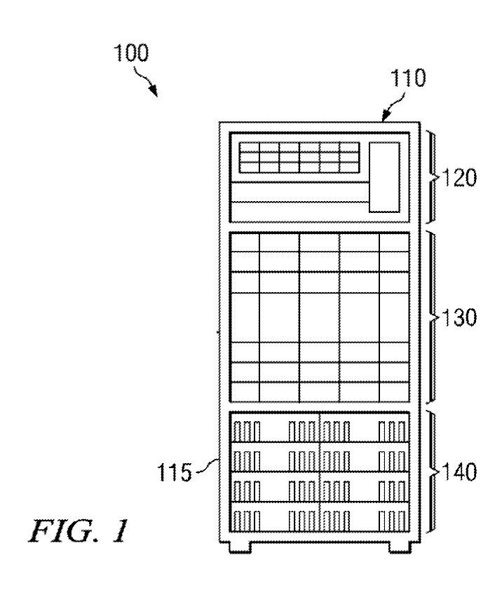

In some configurations of the I/O drawers 140 (FIG. 1) problems may exist. These problems, while not catastrophic, may limit usage of the drawers 140 in some situations. For example, the I/O drawers 140 may have limitations with internal bandwidth and power that does not allow support of new high performance I/O adapters. The I/O adapter 140 may also fail to provide power management capability to reduce overall power consumption or utilize proprietary internal buses versus industry technology (e.g., PCIe bus and switches). Further, some I/O drawers do not provide efficient cooling or may not include native “hardware” attachment of industry standard adapters or accelerators.

In view of these shortcomings, embodiments of the present invention are directed to an I/O drawer. The drawer of the present invention may include improved air flow due to the configuration of the horizontal redundant Air Moving Devices (AMD) (e.g., fans). This may include monitoring internal card temperatures and adjusting AMD speed for optimum power and reliability across the drawer. The drawer may also include a bidirectional fail-over that allows an I/O port to be connected to the host through redundant paths. In one embodiment, the path is front to back through the backplane of the drawer. Embodiments of the I/O drawer of the present invention may allow a service subsystem of the drawer to turn off a single card or single channel port, when function is unused to save power.

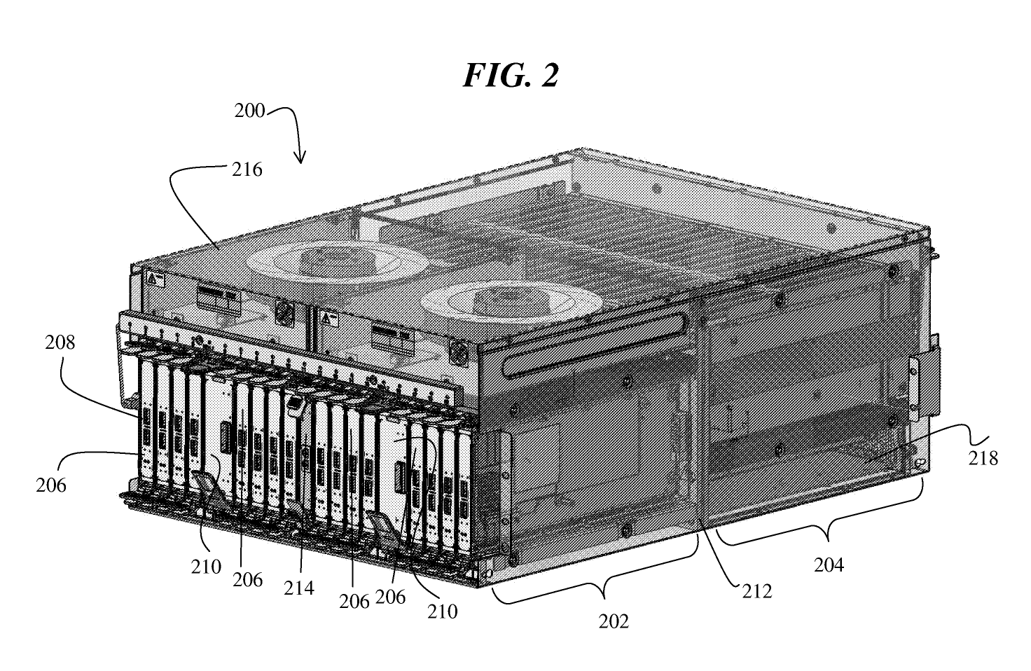

FIG. 2 shows a perspective view of a drawer 200 according to one embodiment. The drawer 200 may be, for example, an I/O drawer but it not so limited. The drawer 200 includes a front portion 202 and a back portion 204. Both the front portion 202 and the back portion 204 include slots to receive various cards. The slots may be arranged next to one another and be referred to herein as “card receiving areas.” In one embodiment, both the front portion 202 and the back portion 204 include card receiving areas.

For example, one or both of the front portion 202 or the back portion 204 may receive I/O cards 206 in the card receiving areas. The I/O cards 206 are received in slots. Each slot may include a connection to a back plane 212 that separates the front portion 202 from the back portion 204.

The I/O cards 206 may include one or more ports 208 for connection to peripheral devices (not shown) such as data storage devices. Both the front portion 202 and the back portion 204 may include I/O cards 206 while in operation.

The drawer 200 may also include slots in the card receiving areas for receiving one or more communications cards 210. The communications cards 210 acts as a go between the computing device and the I/O cards 206. In one embodiment, the communications card 210 is a PCI or PCIe fanout card. In one embodiment, each communication card 210 provide communications for up to eight I/O cards 206 while in operation.

Both the I/O cards 206 and the communications card 210 may be coupled to the backplane 212. A backplane (or “backplane system”) is a circuit board (usually a printed circuit board) that connects several cards in parallel to each other. Information to be provided to an individual I/O card 206 is received from the computing device by the communications card 210 and routed through the backplane 212. In one embodiment, the back plane may provide multiple power connections to the cards in the drawer 200. For example, the backplane 212 may provide both 3.3V and 12V power.

In one embodiment, the drawer 200 may also include one or more flexible support processor (FSP) cards 214. The FSP cards 214 control operation of the backplane 212 and the drawer 200 as a whole. The FSP cards 214, I/O cards 206 and communication cards 210 may be collectively referred to as “cards.”

The drawer 200 may also include one or more AMDs 216. The AMDs 216 may be, for example, fans. Operation of the AMDs 216 may be controlled, for example, by the FSP card. In one embodiment, the AMDs are located above the cards in the front portion 202 of the drawer 200. The AMDs may provide redundant functional air flow paths for air to pass through and cool the cards and may be interconnected to provide failover protection. In one embodiment, the AMDs may be field replaceable units (FRUs) to enable repair and verification in the field.

The drawer 200 may also include one or more distributed current assemblies 218 (DCAs). The DCAs convert high voltage power to the logic levels (e.g., 3.3V and 12V) provided to the cards through the backplane 212. In one embodiment, the DCAs 218 are interconnected to provide failover protection.

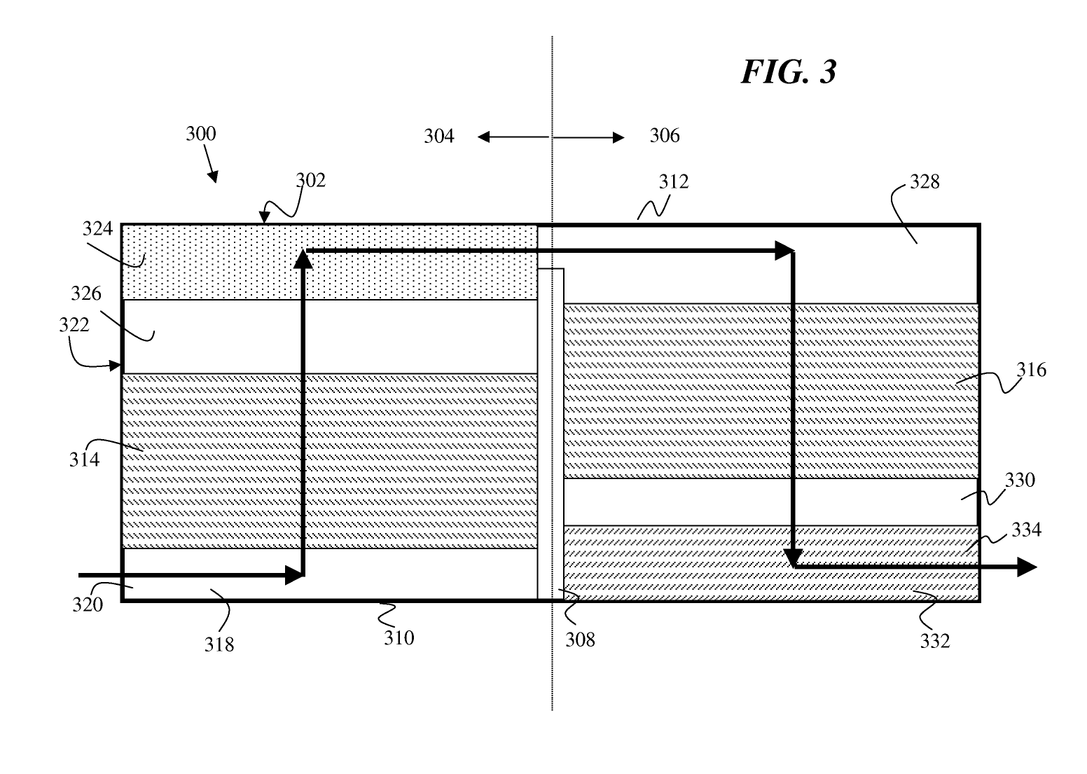

FIG. 3 shows a side view of drawer 300 according to one embodiment. The drawer 300 may include an outer housing 302. The outer housing 302 may support the elements of the drawer and allow it to be mounted into a cage. The drawer 300 may include front portion 304 and back portion 306. The front portion 304 is separated from the back portion 306 by a backplane 308. The backplane 308 may extend only a portion of the distance from a bottom 310 of the housing 302 to a top 312 of the housing 302.

The backplane 308 may include connections for cards on both sides thereof. Accordingly, the front portion 304 may include a front card receiving area 314. Similarly, the back portion 306 may include back card receiving area 316. Both the front card receiving area 314 and the back card receiving area 316 may include any combination of cards. In one embodiment, both the front card receiving area 314 and the back card receiving area 316 are configured and arranged to receive and provide connections for 16 I/O cards, two communications cards (e.g., PCI or PCIe switch cards), and one FSP card.

In one embodiment, the drawer 300 may include an air inlet chamber 318. The air inlet chamber may include an air intake 320 located on a front side 322 of the drawer 300. The air inlet chamber 318 may be located between the front card receiving area 314 and the bottom 310 of the housing 302. The front portion 304 may also include one or more AMD's 324 located over the front card receiving area 314. In one embodiment, the AMD's 324 are separated from the front card receiving area 314 by a first air plenum 326.

In one embodiment, the AMD's 324 such at least a portion thereon contacts the backplane 308. The AMD's 324 may be arranged such that they draw air from below.

In one embodiment, the back portion 308 may include a second air plenum 328. The second air plenum 328 may separate the back card receiving area 316 from the top 312 of the housing 302. In one embodiment, the second air plenum 328 may provide for an air path between the housing 302 and the backplane 308. A third plenum 330 may be located below the back card receiving area 316.

In one embodiment, the drawer 300 may also include one or more DCA's 332 located in the back portion 306. The DCA 332 receives power from an external source at a high voltage. The DCA 332 coverts at a least a portion of this power into logic level voltages (e.g., 3.3V or 12V) and provides it to the backplane 308. These logic level voltages may be provided to I/O cards when such are installed in either or both of the front card receiving area 314 or the back card receiving area 316. The DCA 332 may include an exhaust 334.

In one embodiment, the backplane 308 may also include means for carrying higher voltages. In such an embodiment, the AMDs 324 may receive power from, and be controlled by, the DCA 332 through the backplane 308. In one embodiment, the AMDs 324 may receive at least 350V DC from the DCA 332 through the backplane 308.

In operation, the AMDs 324 cause air to be drawn into the air inlet chamber 318 though the air intake 320. The air is drawn upward through the front card receiving area 314 and cools any cards disposed therein. The AMDs 324 cause the air to travel through the first air plenum 326 and expel it into the second air plenum 328. From the second air plenum 328, air travels through the back card receiving area 316 and cools any cards located therein. The air also travels from the back card receiving area 316 through the third plenum 330 and through the DCAs 332 where it is discharged through exhaust 334. The arrows in FIG. 3 generally show the flow air through the drawer 300 when the AMDs 324 are operational. It shall be understood that additional elements may be located between the elements shown in FIG. 3 without departing from the spirit of the invention disclosed herein. In addition, some or all of the air plenums may be eliminated.

In one embodiment, the AMDs 324 may provide redundant functional airflow paths for air to pass through and cool the cards and may be interconnected to provide failover protection. In one embodiment, the DCAs 332 are interconnected to provide failover protection.

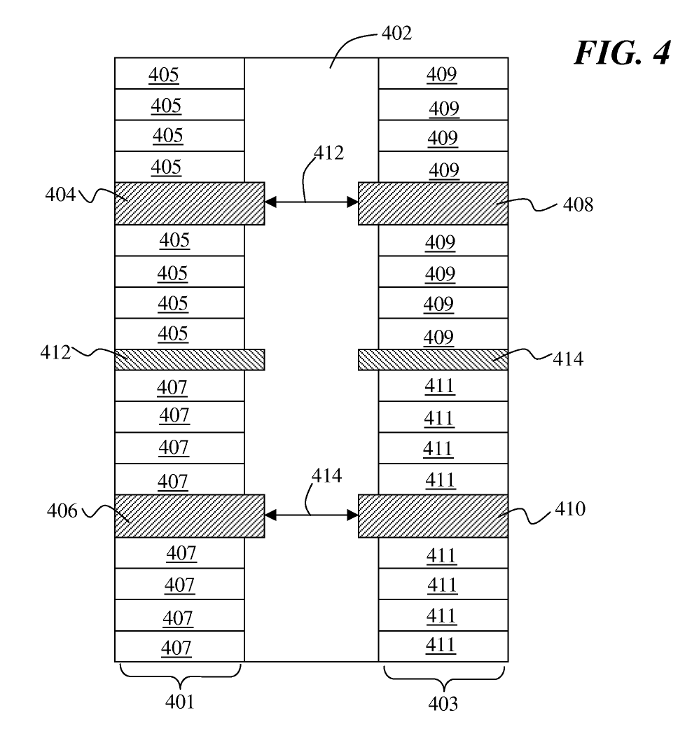

FIG. 4 shows a topological view of a backplane 402 according to one embodiment. The backplane 402 is coupled to several cards. In one embodiment, the backplane 402 may provide one or more logic level voltages to the cards.

In more detail, the backplane 402 may, in one embodiment, include four communications cards 404, 406, 408 and 410. Of course the number of communication cards may be varied. Each communication card 404, 406, 408 and 410 is coupled through the backplane to one or more I/O cards. For example, the first communication card 404 is coupled to a first group of I/O cards 405, the second communication card 406 is coupled to second group of I/O cards 407, the third communication card 408 is coupled to a third group of I/O cards 409 and the fourth communication card 410 is coupled to a fourth group of I/O cards 411. The number of I/O cards each communication card is coupled to may vary.

Each side of the backplane 402 may be coupled to an FSP. For example the first side 401 of the back plane may be coupled to a first FSP 412 and the second side 403 of the backplane 402 may be coupled to a second FSP 414.

In one embodiment, a communication card coupled to the first side 401 may be coupled to a communication card coupled to the second side 403. For example, the first communication card 404 may be coupled to the third communication card 408 and the second communication card 406 may be coupled to the fourth communication card 410. The coupling may be provided, for example, by a bus. For example, the first bus 412 couples the first communication card 404 to the third communication card 408 and the second bus 414 couples the second communication card 406 to the fourth communication card 410. The coupling allows for communication in the event that one of the communication cards fails. In one embodiment, in a communication card on the front side of a drawer is coupled to a communication card on the back side of a drawer through the backplane 402.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A server Input/Output (I/O) drawer for holding one or more communication cards and one or more I/O cards, the drawer comprising:
an outer housing;
a back plane within the outer housing that divides the drawer into a front portion and a back portion, the back plane including a front side and a backside and-configured to receive the one or more I/O cards and the one or more communication communications cards;
an air movement device (AMD) disposed within the front portion and over the one or more I/O cards in the front portion; and
a distributed current assembly (DCA) that receives a voltage from an external source and supplies power, through the backplane, to the AMD and located below the one or more I/O cards in the back portion.

2. The I/O drawer of claim 1, wherein the DCA provides at least 350 DC volts to the AMD.

3. The I/O drawer of claim 1, in combination with the one or more I/O cards and the one or more communications communication cards.

4. The I/O drawer of claim 3, wherein the DCA provides logic level voltages to the one or more I/O cards and the one or more communication cards.

5. The I/O drawer of claim 4, wherein the logic level voltages include one or both of 3.3V and 12V.

6.-16. (canceled)
